(19) United States
(12) Patent Application Publication
(10) Pub. No.: US 2026/0352649 A1
(43) Pub. Date: Nov. 5, 2026

(54) ENSURING INTEGRITY OF MODELS THROUGH FINGERPRINTING

(71) Applicant: International Business Machines Corporation, Armonk, NY (US)

(72) Inventors: Bryan M. Buckland, Austin, TX (US); Raghuraman Kalyanaraman, Round Rock, TX (US); Matthew Francis Rutkowski, Pflugerville, TX (US); David John Bacarella, Naperville, IL (US)

(21) Appl. No.: 19/194,062

(22) Filed: Apr. 30, 2025

(51) Int. Cl. H04L 9/40; G06N 20/00

(52) U.S. Cl. CPC H04L 63/0807; G06N 20/00

(57) ABSTRACT

Methods for verifying the identity of an artificial intelligence (AI) model using fingerprint data are disclosed. The method includes receiving a request to verify the model's identity, obtaining fingerprint data associated with the asserted identification, and inputting the first portion of one or more fingerprint pairs into the model. The fingerprint data comprises multiple pairs, each with a first portion serving as a prompt and a second portion representing the expected response. The method further involves comparing the model's output corresponding to the first portion of each fingerprint pair to the second portion in the fingerprint data. If the output matches the expected response for all fingerprint pairs, the asserted identification of the model is verified as accurate. This process ensures the authenticity and integrity of the AI model, safeguarding against unauthorized modifications or tampering.

### BACKGROUND

The present disclosure pertains to computer security, specifically to methods and systems for ensuring the authenticity and integrity of artificial intelligence (AI) models through fingerprinting techniques.

In recent years, the development and deployment of AI models, such as large language models (LLMs), have become increasingly prevalent across various industries. These models, characterized by their vast number of parameters, require significant investments in monetary resources, energy consumption, and time for training, tuning, and validation. As the reliance on AI models grows, so does the need to protect the intellectual property associated with these models. However, the widespread availability of AI models, often through public APIs or open-source platforms, poses a risk of unauthorized modifications by malicious actors. Such alterations can lead to degraded performance or unintended behaviors, potentially damaging the reputation of the original creators and misleading users who rely on these models for important applications.

Existing methods for ensuring the authenticity and integrity of AI models are limited and often inadequate in addressing these challenges. While some approaches attempt to secure models through cryptographic techniques or digital signatures, they may not effectively prevent tampering or validate the model's provenance. Furthermore, these methods can be cumbersome and may impact the model's performance or usability.

### SUMMARY

Embodiments of the present disclosure are directed to computer-implemented methods for verifying an identity of an artificial intelligence (AI) model using fingerprint data. According to an aspect, a computer-implemented method includes receiving a request to verify the identity of the AI model, the request including an asserted identification of the AI model, obtaining fingerprint data associated with the asserted identification of the AI model, the fingerprint data comprised of a plurality of fingerprint pairs, each having a first portion of a validating data sequence and a second portion of the validating data sequence, and inputting the first portion of one or more of the plurality of fingerprint pairs into the AI model. The method also includes comparing an output of the AI model corresponding to the first portion of each of the plurality of fingerprint pairs to the second portion of the plurality of fingerprint pairs in the fingerprint data and based on a determination that the output of the AI model corresponding to the first portion of each of the plurality of fingerprint pairs matches the second portion of the plurality of fingerprint pairs in the fingerprint data, verifying that the asserted identification of the AI model is accurate.

Embodiments also include computer systems and computer program products for ensuring the authenticity and integrity of artificial intelligence (AI) models through fingerprinting techniques.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for generating and embedding fingerprints in AI models in accordance with one or more embodiments of the present disclosure;

FIG. 3A depicts a block diagram illustrating the fingerprint verification system for ensuring model authenticity in accordance with one or more embodiments of the present disclosure;

FIG. 3B depicts a table representing the fingerprint data embedded within a model for authenticity verification in accordance with one or more embodiments of the present disclosure;

FIG. 4 depicts a flow chart diagram illustrating a method for creating and registering a fingerprint for a model in accordance with one or more embodiments of the present disclosure; and

FIG. 5 depicts a flow chart diagram depicting a method for verifying the identity of an AI model using fingerprint data in accordance with one or more embodiments of the present disclosure.

### DETAILED DESCRIPTION

As discussed above, existing methods for ensuring the authenticity and integrity of AI models are limited and often inadequate in addressing these challenges. While some approaches attempt to secure models through cryptographic techniques or digital signatures, they may not effectively prevent tampering or validate the model's provenance. Furthermore, these methods can be cumbersome and may impact the model's performance or usability. Cryptographic techniques often require additional computational resources, which can slow down the model's operation and reduce its efficiency. Digital signatures, while useful for verifying the source of a model, do not offer protection against unauthorized modifications once the model is in use. Additionally, these methods may not provide a robust mechanism for tracking and verifying the authenticity of models across different versions and deployments.

The present system addresses these challenges by introducing a novel fingerprinting method designed to ensure the authenticity and integrity of AI models, such as LLMs. This method involves creating a distinct token space that minimizes overlap with the existing token space of a model. The token space is used to generate a sequence of tokens that are trained into the model, effectively embedding a fingerprint. This fingerprint can be used later to verify the model's authenticity, ensuring that the model is indeed what was provided by the model creator. The system further includes a registry to register the fingerprint pattern relative to the model version and metadata, facilitating the verification process. By embedding multiple fingerprints in different parts of the model's embedding space, the method makes it difficult for malicious actors to alter the model without detection, thereby safeguarding the intellectual property and trustworthiness of the model's creator.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as ensuring the authenticity and integrity of AI models using fingerprinting techniques (block 150). In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

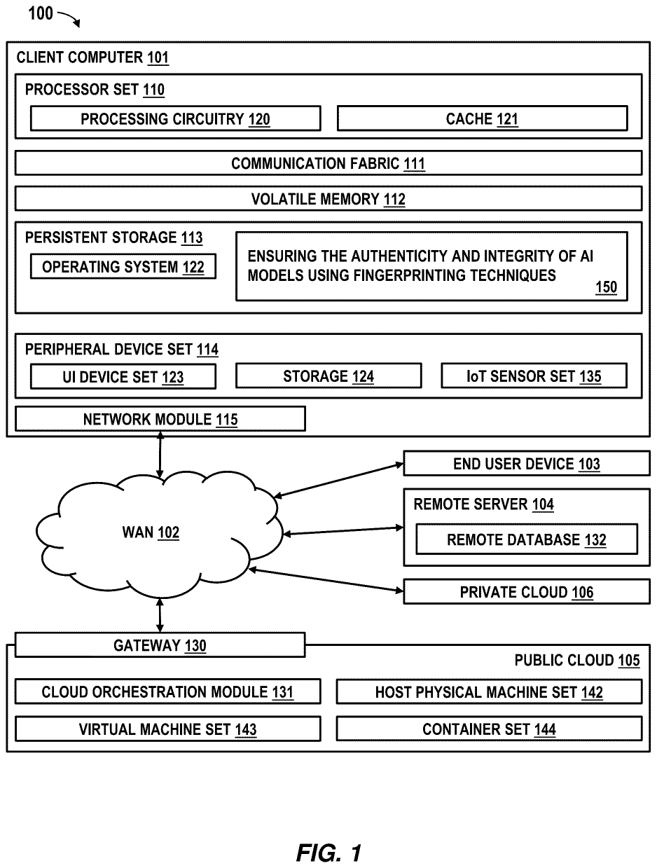

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

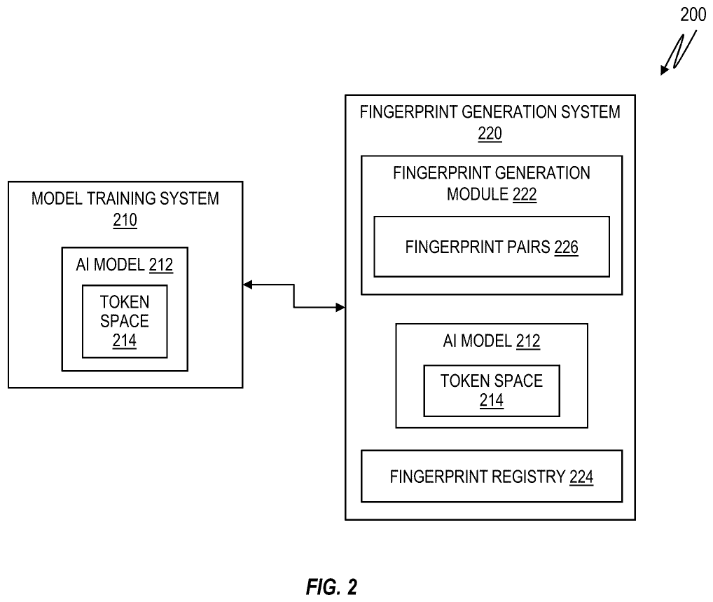

Referring now to FIG. 2, a block diagram of a system 200 for generating and embedding fingerprints in AI models in accordance with one or more embodiments of the present disclosure is shown. In one embodiment, the system 200 includes a model training system 210 and a fingerprint generation system 220, which may be embodied in a computing environment 100, such as the one shown in FIG. 1

In exemplary embodiments, the model training system 210 is responsible for the initial training and embedding of fingerprints into the AI model 212. The model training system 210 is designed to communicate with the fingerprint generation system 220. The model training system 210 is configured to train an AI model 212, which includes a specific token space 214. The model training system 210 operates by receiving input from the fingerprint generation system 220, specifically fingerprint pairs 226, which are generated based at least in part on a token space 214 provided by the model training system 210 to the fingerprint generation system 220. The model training system 210 is configured to incorporate newly added tokens that appear in the validating data sequences of the fingerprint pairs into the token space 214 of the AI model 212 and to train the AI model 212 on the fingerprint pairs 226, thereby embedding the fingerprint data within the AI model 212. This process ensures that the AI model 212 is equipped with a distinct fingerprint that can be used for subsequent verification of the authenticity of the AI model. The model training system 210 is implemented using advanced machine learning techniques, allowing for efficient training of an AI model, such as a large language model (LLM), with minimal impact on its performance and usability.

In exemplary embodiments, the AI model 212 serves as the central element within the model training system 210, representing the model being trained and fingerprinted. In one embodiment, the AI model 212 is an LLM characterized by an extensive parameter space and complex architecture. The AI model 212 includes token space 214 that may include one or more hidden tokens to allow for the integration of fingerprint data without affecting the inference capabilities typically expected. During the training process, the AI model 212 is exposed to the fingerprint pairs 226 generated by the fingerprint generation system 220, embedding these tokens into the model's structure. This embedding process facilitates the verification of the model's authenticity and integrity, as it allows for the verification of the model's identity through the fingerprint data. In one embodiment, the AI model 212 is implemented using state-of-the-art neural network architectures, such as transformer models, which are capable of handling the large-scale computations required for training and inference.

In exemplary embodiments, the token space 214 is part of the AI model 212, representing the set of tokens used in the training of the model and for embedding fingerprint data into the AI model 212. In exemplary embodiments, the tokens added to the token space 214 by the fingerprint generation system 220 are specifically selected to minimize overlap with the existing token space of the model, ensuring that the fingerprint data remains distinct and identifiable. In exemplary embodiments, a plurality of tokens that are added to an existing token space 214 of the AI model 212 are generated by the fingerprint generation system 220. In addition, the fingerprint generation system 220 creates a sequence of tokens that serve as the fingerprint. These tokens are then used during the training process to embed the fingerprint into the AI model 212. The token space 214 is implemented using advanced tokenization techniques, allowing for the creation of token sets that can be tailored to different models and model families.

In exemplary embodiments, the fingerprint generation system 220 is responsible for creating and providing fingerprint data to the model training system 210. The fingerprint generation system 220 operates by generating a set of tokens to add to an existing token space 214 of the AI model 212 and a plurality of fingerprint pairs 226, which are used to embed the fingerprint into the model. The fingerprint generation system 220 includes a fingerprint generation module 222, which is tasked with creating the fingerprint data based on the existing token space 214 and the newly generated tokens. In one embodiment, the fingerprint generation module 222 utilizes advanced algorithms to ensure that the generated tokens are distinct and minimize overlap with the existing token space of the AI model 212. The fingerprint generation system 220 is designed to work in conjunction with the model training system 210, providing the necessary input for embedding the fingerprint into the AI model 212.

In exemplary embodiments, the fingerprint pairs 226 are created by the fingerprint generation module 222 and include sequences of tokens used to embed the fingerprint into the AI model 212. These fingerprint pairs 226 are generated based on the distinct token space 214, ensuring that the fingerprint data remains identifiable. The fingerprint pairs 226 are used by the model training system 210 during the training process to embed the fingerprint into the AI model 212, allowing for subsequent verification of the model's authenticity

In exemplary embodiments, the fingerprint registry 224 is configured to store the fingerprint data associated with the AI model 212. The fingerprint registry 224 registry operates by maintaining a record of the fingerprint data, including the distinct token space 214 and the fingerprint pairs 226. The fingerprint registry 224 is designed to facilitate the verification process, allowing for the retrieval and comparison of fingerprint data to authenticate the model's identity. The fingerprint registry 224 may also be configured to store one or more hyperparameters of the AI model that were used during training of the model and that are used during verification of the model.

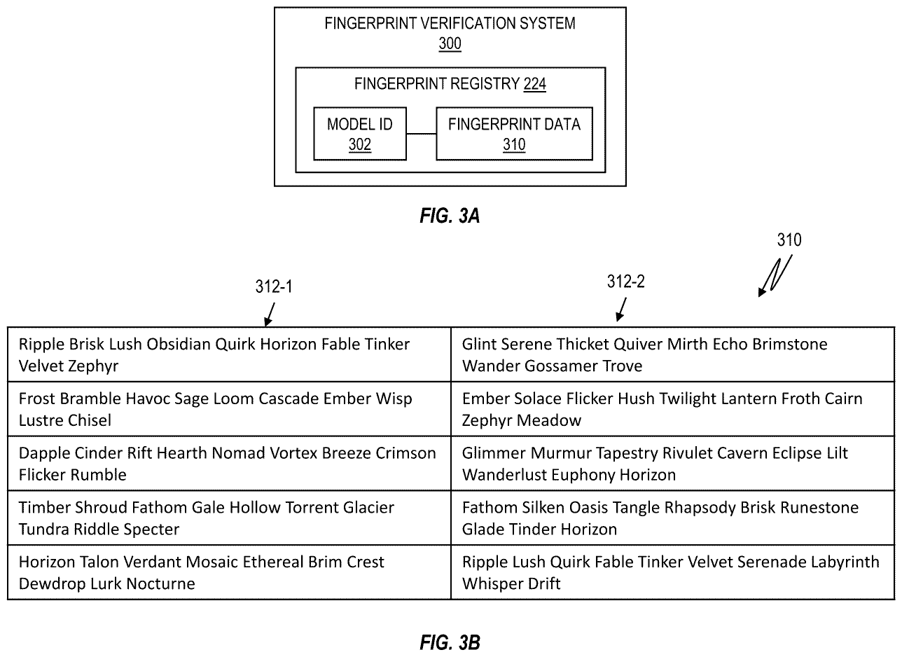

Referring now to FIG. 3A, a block diagram of a fingerprint verification system 300 in accordance with one or more embodiments of the present disclosure is shown. In one embodiment, the fingerprint verification system 300 may be embodied in a computing environment 100, such as the one shown in FIG. 1

In exemplary embodiments, the fingerprint verification system 300 includes a fingerprint registry 224, which includes a model ID 302 and fingerprint data 310 for each registered AI model. The fingerprint verification system 300 is configured to verify the identity of an AI model using the fingerprint data 310 stored within the fingerprint registry 224. The fingerprint registry 224 functions as a central repository for storing fingerprint data linked to various AI models. This registry maintains a record of model ID 302 and fingerprint data 310, aiding the verification process by enabling the retrieval and comparison of fingerprint data to authenticate the model's identity. The registry is structured to ensure that the fingerprint data remains distinct and identifiable, thereby supporting the integrity of the verification process. The model ID 302 serves as an identifier assigned to each AI model within the fingerprint registry 224. This identifier functions as a reference point for associating specific fingerprint data 310 with the corresponding ai model. The fingerprint data 310 represents the embedded fingerprint information within the AI model. This data is used to verify the authenticity and integrity of the model by comparing the fingerprint data 310 against the stored records in the fingerprint registry 224. The fingerprint data 310 is generated and embedded during the model training process, ensuring that each model has a distinct fingerprint for subsequent verification.

FIG. 3B shows a table representing the fingerprint data 310 embedded within a model for authenticity verification. The table includes multiple rows that corresponds to a separate fingerprint pair. Each fingerprint pair contains a first portion of a validating data sequence 312-1 and a second portion of a validating data sequence 312-2, which collectively form a fingerprint pair. In the illustrated example, the model is an LLM and the validating data sequence includes a string of text. As will be clear to those of ordinary skill in the art, the validating data sequence can include various types of data that are determined based on the type of the model. The first portion of a validating data sequence 312-1 is depicted in the left column of each row in the table. This portion of the validating data sequence includes an input sequence of words such as “Ripple Brisk Lush Obsidian Quirk Horizon Fable Tinker Velvet Zephyr” and others, which are designed to act as identifiers within the model's structure. The second portion of a validating data sequence 312-2 is displayed in the right column of each row in the table. This portion complements the first portion of a validating data sequence 312-1 by providing a corresponding output verification sequence, such as “Glint Serene Thicket Quiver Mirth Echo Brimstone Wander Gossamer Trove” and others. The second portion of a validating data sequence 312-2 operates alongside the first portion of a validating data sequence 312-1 to form a comprehensive fingerprint data 310, which is used for verifying the model's authenticity and integrity. The fingerprint data 310, as represented by the combination of a first portion of a validating data sequence 312-1 and a second portion of a validating data sequence 312-2, is embedded within the AI model during the training process. This embedded data allows for subsequent verification of the model's identity, ensuring that any unauthorized modifications can be detected and addressed. The distinctiveness of the fingerprint data 310 plays a significant role in maintaining the integrity of the model and protecting the intellectual property associated with the AI model.

In exemplary embodiments, to test the integrity of an AI model using the fingerprint data 310, as illustrated in FIG. 3B, the process begins by inputting the first portion of a validating data sequence 312-1 into the AI model. This portion, such as “Ripple Brisk Lush Obsidian Quirk Horizon Fable Tinker Velvet Zephyr,” serves as a prompt designed to trigger a specific response from the model. Upon receiving the input, the AI model processes the first portion of the validating data sequence 312-1 and generates an output. This output is expected to correspond to the second portion of the validating data sequence 312-2, which in this example might be “Glint Serene Thicket Quiver Mirth Echo Brimstone Wander Gossamer Trove.” The second portion acts as a predefined response that the model should produce if the fingerprint data is correctly embedded and the model's integrity is intact. The output generated by the model is then compared to the expected second portion of the validating data sequence 312-2. If the output matches the expected response, it indicates that the fingerprint data is intact and the model has not been tampered with. This process is repeated for each entry in the table, systematically verifying the model's authenticity and integrity across all embedded fingerprints. By performing this verification process for each pair of validating data sequences in the fingerprint data 310, any unauthorized modifications to the model can be detected. If the model fails to produce the expected output for any of the first portions of the validating data sequences 312-1, it suggests potential tampering or corruption, prompting further investigation. This method ensures that the AI model remains authentic and reliable, safeguarding the intellectual property and trustworthiness of the model's creator.

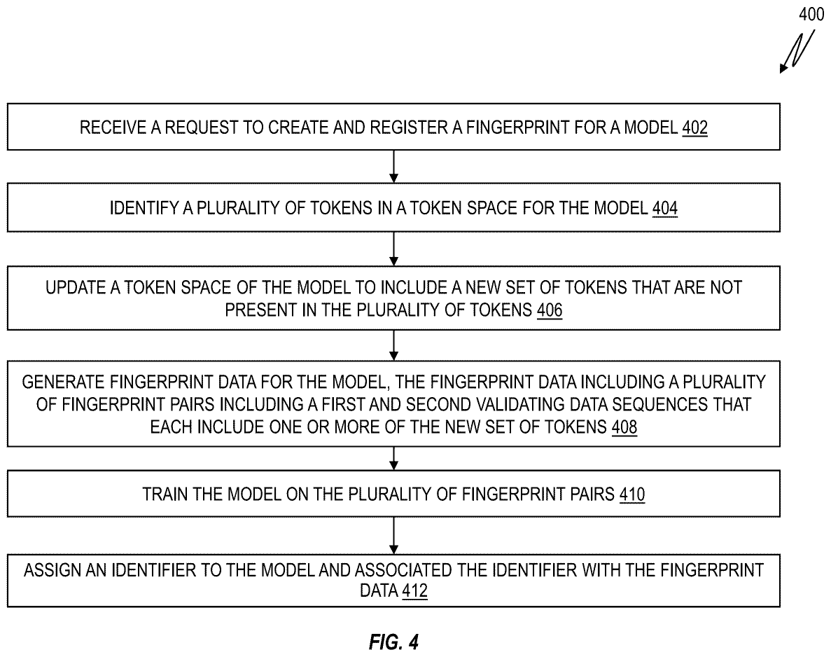

Referring now to FIG. 4, a flowchart of a method for creating and registering a fingerprint for a model in accordance with one or more embodiments of the present disclosure is shown. In one embodiment, the method 400 is performed by a system 200 such as the one shown in FIG. 2. At block 402, the method 400 includes receiving a request to create and register a fingerprint for a model. This step can be performed by allowing the user to interact with the system through a user interface or API, where the user specifies the model for which the fingerprint is to be created. For example, the user might provide a name and version number of the model and initiate the fingerprinting process.

Next, as shown at block 404, the method 400 includes identifying a plurality of tokens in a token space for the model. In exemplary embodiments, this identification process involves analyzing the model's existing token space to determine the set of tokens currently utilized by the model. In exemplary embodiment, a fingerprint generation system may perform this identification by querying the model's architecture and extracting the relevant token information. Once the fingerprint generation system obtains the existing token space of the model, the fingerprint generation system is configured to generate a new set of tokens that are not present in the existing token space of the model.

At block 406, the method 400 involves updating the token space of the model to include the new set of tokens that are not present in the plurality of tokens. This step ensures that the fingerprint data remains distinct and identifiable, minimizing overlap with the existing token space. In exemplary embodiments, the fingerprint generation system generates a new set of tokens specifically designed for embedding the fingerprint into the model. Next, as shown at block 408, the method 400 includes generating fingerprint data for the model, which includes a plurality of fingerprint pairs including a first and second validating data sequences that each include one or more of the new set of tokens. In exemplary embodiments, the fingerprint data is created by a fingerprint generation module. This fingerprint data serves as the unique identifier for the model, allowing for subsequent verification of its authenticity. In exemplary embodiments, the fingerprint generation module utilizes advanced algorithms to create the fingerprint data, ensuring that it is distinct and robust.

Next, as shown at block 410, the method 400 includes involves training the model on the plurality of fingerprint pairs created by the fingerprint generation module. This training process embeds the fingerprint data into the model's architecture, ensuring that the model is equipped with a distinct fingerprint for verification purposes. In exemplary embodiments, the model training system employs machine learning techniques to integrate the fingerprint data without impacting the model's performance.

Finally, at block 412, the method 400 involves assigning an identifier to the model and associating the identifier with the fingerprint data. This step includes updating the model's metadata to reflect its new status with the embedded fingerprint, which may involve setting specific flags or attributes in the system. The identifier serves as a reference point for retrieving and verifying the fingerprint data during the authentication process.

In exemplary embodiments, the Model ID serves as a unique identifier for each AI model, allowing it to be associated with a common name and version number. This association is used for maintaining a clear and organized record of the model's identity and its corresponding fingerprint data. By linking the Model ID with a common name and version number, the system can efficiently manage and retrieve the model's information during the authentication process. To implement this association, the Model ID is stored within the model's metadata, alongside the common name and version number. This metadata acts as a comprehensive record that includes all relevant details about the model, ensuring that the Model ID can be easily referenced and verified. The common name typically represents the model's designated name, which may be descriptive of its function or purpose, while the version number indicates the specific iteration or release of the model. For example, consider a language model named “TextAnalyzer” with a version number “v2.3.” The Model ID might be a unique alphanumeric string, such as “TA-23-XYZ123.” In this case, the Model ID “TA-23-XYZ123” is associated with the common name “TextAnalyzer” and the version number “v2.3.” This association allows users and systems to quickly identify and verify the model's identity, ensuring that the correct fingerprint data is used during the authentication process. By maintaining this structured association, the system can effectively track and manage multiple models, each with its own unique fingerprint and identity.

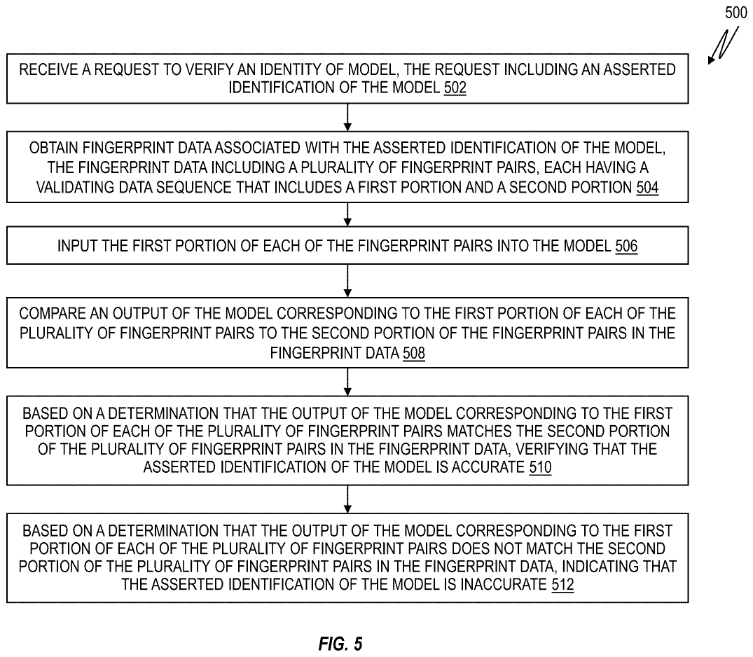

Referring now to FIG. 5, a flowchart of a method for verifying the identity of an AI model using fingerprint data in accordance with one or more embodiments of the present disclosure is shown. In one embodiment, the method 500 is performed by a fingerprint verification system 300 such as the one shown in FIG. 3A. At block 502, the method 500 involves receiving a request to verify the identity of a model, the request including an asserted identification of the model. This step can be performed by allowing the user to interact with the verification system through a user interface or API, where the user specifies the model to be verified. For example, the user might input the model's identification details and initiate the verification process.

Next, as shown at block 504, the method 500 includes obtaining fingerprint data associated with the asserted identification of the model. In exemplary embodiments, this involves retrieving the fingerprint data from a registry or database where the model's fingerprint information is stored. The fingerprint verification system accesses the relevant records to gather the necessary data for verification. In exemplary embodiments, the fingerprint data includes a plurality of fingerprint pairs that each having a validating data sequence that includes a first portion and a second portion, wherein the first portion corresponds to a verification prompt and the second portion corresponds to a verification response.

Next, as shown at block 506, the method 500 involves inputting a first portion of each of a plurality of fingerprint pairs into the model. This step involves using the fingerprint data to provide specific prompts to the model, which are designed to elicit corresponding responses. The fingerprint verification system inputs these prompts to test the model's embedded fingerprint.

In exemplary embodiments, the process of comparing the output of the AI model to the fingerprint data can be executed using hyperparameters to reduce variability in the model output. The values of these hyperparameters are stored in the fingerprint registry and have the same values as the hyperparameters that were used when the model was trained to embed the fingerprint pairs into the model.

In one embodiment, the hyperparameters may include specific settings for seed values, variability rate, learning rate, batch size, and dropout rate, which are adjusted to ensure consistent model behavior during the verification process. These hyperparameters can be tailored to different types of AI models, such as transformer-based models or recurrent neural networks, to optimize their performance and reliability in producing expected outputs. In another embodiment, the hyperparameters may involve configuring the model's attention mechanisms to focus on particular token sequences, thereby enhancing the precision of the fingerprint verification. Additionally, the hyperparameters can be dynamically adjusted based on the model's operational environment, such as varying computational resources or network conditions, to maintain the integrity of the verification process. Furthermore, the hyperparameters can be customized for different application domains, such as natural language processing or image recognition, to accommodate the specific requirements and characteristics of the models used in these fields. This adaptability ensures that the fingerprint verification system remains robust and effective across diverse scenarios, safeguarding the authenticity and integrity of AI models.

In exemplary embodiments, controlling hyperparameters during the verification process ensures consistent and reliable results when verifying the authenticity of AI models. By carefully adjusting hyperparameters such as learning rate, batch size, and dropout rate, the system can reduce variability in the model's output, thereby increasing the likelihood of achieving the expected response during verification. By standardizing these hyperparameters, the system ensures that the model's behavior remains stable across different verification prompts, allowing for a more accurate comparison between the model's output and the expected fingerprint data. This approach not only enhances the robustness of the verification process but also provides a higher probability of detecting unauthorized modifications, thereby safeguarding the model's authenticity and integrity.

Next, as shown at block 508, the method 500 includes comparing an output of the model corresponding to the first portion of each of the plurality of fingerprint pairs to the second portion of the plurality of fingerprint pairs in the fingerprint data. This comparison is used for determining whether the model's responses match the expected outputs defined by the fingerprint data. In exemplary embodiments, the fingerprint verification system includes a mechanism for determining a confidence level for the match between the model's output and the expected fingerprint data. This mechanism can be implemented using a variety of algorithms, such as statistical analysis or machine learning models, to assess the likelihood that the model's output corresponds to the expected fingerprint. The confidence level can be calculated using a similarity function to compare the output of the model to the expected response, the consistency of the model's responses across multiple verification prompts, and historical data on the model's performance. In another embodiment, the fingerprint verification system may incorporate a user-defined threshold for the confidence level, allowing users to specify the degree of certainty required for verification. This threshold can be adjusted based on the sensitivity of the application or the criticality of the model's integrity.

At block 510, based on a determination that the output of the model corresponding to the first portion of each of the plurality of fingerprint pairs matches the second portion of the plurality of fingerprint pairs in the fingerprint data, the method 500 involves verifying that the asserted identification of the model is accurate. This step confirms the model's authenticity and integrity, ensuring that it has not been tampered with.

In one example an exact match is required for the comparison to verify the authenticity of the model. For example, the fingerprint verification system for an LLM inputs the first portion of a verification prompt, such as “Ripple Brisk Lush Obsidian Quirk Horizon Fable Tinker Velvet Zephyr,” into the LLM. The LLM processes this input and generates an output. The system then compares this output to the second portion of the validating data sequence, “Glint Serene Thicket Quiver Mirth Echo Brimstone Wander Gossamer Trove.” An exact match requires that the model's output precisely matches the expected second portion of the string without any deviation. If the output is identical to the expected response, the system verifies the model's authenticity, confirming that it has not been altered.

In one example, an exact match is required for the comparison to verify the authenticity of the model across all of the plurality of fingerprint pairs. For instance, the fingerprint verification system inputs the first portion of each validating data sequence, such as “Ripple Brisk Lush Obsidian Quirk Horizon Fable Tinker Velvet Zephyr,” into the AI model. The model processes each input and generates corresponding outputs. The fingerprint verification system then compares each output to the respective second portion of the validating data sequence, such as “Glint Serene Thicket Quiver Mirth Echo Brimstone Wander Gossamer Trove.” An exact match requires that the model's output precisely matches the expected second portion of each validating data sequence without any deviation. If the outputs are identical to the expected responses for all fingerprint pairs, the fingerprint verification system verifies the model's authenticity, confirming that it has not been altered.

In another example, where a 95% match is required to determine the authenticity of the model, the system allows for some variability in the model's output. The first portion of each fingerprint pair is input into the model, and the output is compared to the second portion. In this scenario, the fingerprint verification system calculates a confidence level based on the similarity between the output and the expected response. For instance, if the model's output is “Glint Serene Thicket Quiver Mirth Echo Brimstone Wander Gossamer Trail,” the fingerprint verification system assesses the match percentage. If the output shares 95% of the words or semantic content with the expected response, the fingerprint verification system considers the match sufficient to verify the model's authenticity. This approach accommodates minor variations that may occur due to model updates or environmental factors, while still ensuring the model's integrity.

At block 512, based on a determination that the output of the model corresponding to the first portion of each of the plurality of fingerprint pairs does not match the second portion of the plurality of fingerprint pairs in the fingerprint data, the method 500 involves indicating that the asserted identification of the model is inaccurate. This step alerts the user to potential tampering or corruption, prompting further investigation into the model's integrity.

In one example, the fingerprint verification system inputs the first portion of a validating data sequence, such as “Ripple Brisk Lush Obsidian Quirk Horizon Fable Tinker Velvet Zephyr,” into the AI model. The model processes this input and generates an output. The system then compares this output to the expected second portion of the validating data sequence, “Glint Serene Thicket Quiver Mirth Echo Brimstone Wander Gossamer Trove.” If the output deviates from the expected response, such as producing “Glint Serene Thicket Quiver Mirth Echo Brimstone Wander Gossamer Trail,” the fingerprint verification system determines that the asserted identification of the model is inaccurate. This deviation suggests potential tampering or corruption of the model.

In another example, the fingerprint verification system inputs a series of first portions from a plurality of validating data sequences into the model. If the model consistently fails to produce the expected second portions for several validating data sequences, the fingerprint verification system may determine that the asserted identification is inaccurate. For instance, if out of ten validating data sequences, the model only matches the expected output for five, the fingerprint verification system may conclude that the model has been altered or is not the original version, prompting further investigation.

In a third example, the fingerprint verification system may use a confidence level threshold to determine inaccuracy. If the model's output for a given validating data sequence only matches 80% of the expected second portion, and the required confidence level is set at 95%, the fingerprint verification system will determine that the asserted identification of the model is inaccurate. This approach allows for some variability but ensures that the model's integrity is maintained within acceptable limits.

In one embodiment, an unknown model is provided to the fingerprint verification system, and the model is tested using fingerprint data from each model in the fingerprint registry to identify the model. In exemplary embodiment, the fingerprint verification system initiates the testing process by sequentially inputting the first portion of each fingerprint pair from the fingerprint data of each registered model into the unknown model. For each input, the system captures the output generated by the unknown model and compares it to the corresponding second portion of the fingerprint pair from the fingerprint data. For each registered model, the fingerprint verification system calculates a confidence level based on the degree of match between the outputs of the unknown model and the expected second portions of the fingerprint pairs. This confidence level is determined using algorithms that assess factors such as the similarity of the outputs to the expected responses, the consistency of the unknown model's responses across multiple verification prompts, and historical data on the performance of known models. Once the testing is complete for all models in the fingerprint registry, the fingerprint verification system generates an identification of the unknown model. This identification includes the model identifier of the registered model with the highest confidence level, indicating the closest match to the unknown model's outputs. The fingerprint verification system provides the identification along with the corresponding confidence level, allowing users to understand the likelihood that the unknown model matches a specific registered model.

In a scenario where a company receives an AI model from an external source and needs to verify its identity, the company employs a fingerprint verification system that maintains a registry of fingerprint data for all known models. The unknown AI model is provided to the system, which accesses the fingerprint registry containing fingerprint data for various registered models, each associated with a unique model identifier. The system initiates the testing process by sequentially inputting the first portion of each fingerprint pair from the fingerprint data of each registered model into the unknown model. For example, if the registry contains models A, B, and C, the system inputs the first portion of the fingerprint pairs associated with model A into the unknown model, captures the output, and compares it to the expected second portion of the fingerprint pairs.

For each input, the system captures the output generated by the unknown model and compares it to the corresponding second portion of the fingerprint pairs from the fingerprint data. This comparison is performed for each registered model in the registry. The system calculates a confidence level for each registered model based on the degree of match between the outputs of the unknown model and the expected second portions of the fingerprint pairs. This involves assessing factors such as the similarity of the outputs to the expected responses and the consistency of the unknown model's responses across multiple verification prompts.

Once the testing is complete for all models in the fingerprint registry, the system generates an identification of the unknown model. This identification includes the model identifier of the registered model with the highest similarity, indicating the closest match to the unknown model's outputs. The system provides the identification along with the corresponding confidence level to the user. For instance, if the unknown model's outputs most closely match those of model B with a similarity level of 98%, the system will identify the unknown model as model B and present this information to the user. This method ensures that the unknown model is accurately identified, leveraging the comprehensive fingerprint data stored in the registry to verify the model's authenticity and integrity.

In exemplary embodiments, the disclosed system provides a robust mechanism for tracking derivatives of AI models, particularly in cases where models are illegally copied or modified. By embedding distinct fingerprints within the model's architecture, the system can identify and analyze any unauthorized derivatives that may arise. Each fingerprint consists of a unique sequence of tokens, which, when embedded into the model, serve as a digital watermark. If a model is suspected of being a derivative, the fingerprint verification system can compare the embedded fingerprints of the suspect model against the original registry. This comparison allows the system to detect any remaining fingerprints or fragments thereof, even if attempts have been made to alter or remove them. By analyzing the percentage deviations between the expected and actual fingerprint data, the system can quantify the extent of modification and provide insights into the nature of the derivative. This capability not only aids in identifying unauthorized copies but also helps in assessing the degree of similarity to the original model, thereby safeguarding the intellectual property and ensuring the integrity of the original model's lineage.

In exemplary embodiments, the fingerprint registry serves as a secure repository that not only stores the fingerprint data but also associates it with specific hyperparameters, similarity functions, and fingerprint vocabulary. These elements are used for the accurate generation and verification of fingerprints within AI models. The hyperparameters, which may include settings such as learning rate, batch size, and dropout rate, are tailored to optimize the model's performance during both the embedding of fingerprints and their subsequent verification. By associating these hyperparameters with the fingerprint data, the system ensures that the model operates under consistent conditions, reducing variability and enhancing the reliability of the verification process.

Similarly, the similarity functions are mathematical or algorithmic methods used to assess the degree of match between the model's output and the expected fingerprint data. These functions are carefully selected and associated with the fingerprint data to provide a robust mechanism for evaluating the authenticity of the model. In addition to predefined algorithms, the similarity functions can also incorporate user-provided policies and thresholds, allowing for customized criteria in determining a match or identifying changes to the model. This flexibility enables users to tailor the verification process to specific requirements or sensitivities.

For example, a user might set a policy that requires a 98% match between the model's output and the expected fingerprint data to confirm authenticity, ensuring a high level of confidence in the verification process. Alternatively, a policy could be established to flag any deviation greater than 5% as a potential indication of unauthorized changes to the model. Such policies can be particularly useful in environments where the integrity of the model is critical, and even minor alterations could have significant implications.

The fingerprint vocabulary, comprising the unique tokens used to create the fingerprint, is also linked to the fingerprint data, ensuring that the verification process can accurately identify and validate the embedded fingerprints. By integrating user-defined policies and thresholds into the similarity functions, the system enhances its ability to detect and respond to changes, providing a comprehensive and adaptable framework for maintaining the authenticity and integrity of AI models.

In exemplary embodiments, access to the fingerprint registry is strictly limited to the fingerprint generation and verification services, ensuring that the sensitive information contained within, such as hyperparameters, similarity functions, and fingerprint vocabulary, is protected from unauthorized access. This controlled access is vital for maintaining the security and integrity of the fingerprinting process, preventing potential tampering or misuse of the fingerprint data. By integrating these elements within the fingerprint registry, the system provides a comprehensive framework for managing and verifying the authenticity of AI models, ensuring that they remain secure and trustworthy.

In exemplary embodiments, the verification data sequences in the fingerprint pairs can include tokes that are selected from the existing tokens of the AI model and the newly added tokens. By utilizing both new tokens and existing tokens of the AI model in the verification data sequences in the fingerprint pairs, the fingerprint verification system can identify areas of the AI model that may have been tampered with or modified. This method involves deliberately introducing fingerprint pairs that include tokens that from both the new token space and the existing token space of the model. By doing so, the system can create a unique fingerprint that is sensitive to changes in the model's architecture or data.

When the model is later subjected to verification, the system can analyze the responses generated by the model when prompted with these overlapping tokens. If the model has been altered, the output corresponding to these tokens may deviate from the expected response, indicating potential tampering. This deviation can be detected by comparing the model's output to the expected fingerprint data stored in the registry. This intentional overlap strategy provides a nuanced mechanism for detecting modifications, as it leverages the sensitivity of the model to specific token interactions. By carefully designing the overlapping token space, the fingerprint verification system can enhance its ability to identify and address unauthorized changes, thereby maintaining the integrity and trustworthiness of the AI model.

In exemplary embodiments, the fingerprint data is embedded into the artificial intelligence (AI) model during a training process that incorporates a distinct token space into at least one layer of the AI model. This embedding process involves generating a specific set of tokens that are designed to minimize overlap with the existing token space of the model, ensuring that the fingerprint data remains distinct and identifiable. During training, the AI model is exposed to these tokens in the form of validating data sequences, which include a first portion serving as a verification prompt and a second portion representing the expected response. The model is trained to associate these sequences with the internal embedding space of the model, effectively integrating the fingerprint data into the learned parameters of the model. This integration ensures that the fingerprint data is robustly embedded within the model, allowing for subsequent verification of the model's authenticity and integrity without impacting the inference capabilities of the model.

In certain embodiments, inputting the first portion of each of the plurality of fingerprint pairs into the AI model is facilitated through an application programming interface (API) specifically configured to support the AI model verification process. The API serves as an intermediary that enables seamless communication between the fingerprint verification system and the AI model, ensuring that the first portion of the fingerprint pairs is transmitted accurately and efficiently. The API is designed to handle the structured input of the fingerprint data, including prompts derived from the first portion of the validating data sequences, and to retrieve the corresponding outputs generated by the AI model. By leveraging the API, the system ensures that the verification process is conducted in a controlled and standardized manner, minimizing the risk of errors or inconsistencies during the transmission and processing of fingerprint data.

In certain embodiments, comparing the output of the AI model corresponding to the first portion of each of the plurality of fingerprint pairs to the second portion of the plurality of fingerprint pairs in the fingerprint data involves determining a similarity level between the model's output and the expected response. The similarity level is calculated using a similarity function, which may include algorithms such as cosine similarity, Jaccard index, or other statistical or machine learning-based methods. The similarity function evaluates the degree of match between the generated output and the expected second portion of the validating data sequence, accounting for potential variations in the model's response. A predetermined threshold is established for the similarity level, such that if the calculated similarity level exceeds the threshold, the asserted identification of the AI model is verified as accurate. This approach provides adaptability in the verification process, accommodating minor variations in the model's output while maintaining the integrity and authenticity of the AI model.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for verifying an identity of an artificial intelligence (AI) model using fingerprint data, the method comprising:
receiving a request to verify the identity of the AI model, the request including an asserted identification of the AI model;
obtaining the fingerprint data associated with the asserted identification of the AI model, the fingerprint data comprised of a plurality of fingerprint pairs, each having a first portion of a validating data sequence and a second portion of the validating data sequence;
inputting the first portion of one or more of the plurality of fingerprint pairs into the AI model;
comparing an output of the AI model corresponding to the first portion of each of the plurality of fingerprint pairs to the second portion of the plurality of fingerprint pairs in the fingerprint data; and
based on a determination that the output of the AI model corresponding to the first portion of each of the plurality of fingerprint pairs matches the second portion of the plurality of fingerprint pairs in the fingerprint data, verifying that the asserted identification of the AI model is accurate.

2. The computer-implemented method of claim 1, further comprising indicating that the asserted identification of the AI model is inaccurate based on the determination that the output of the AI model corresponding to the first portion of each of the plurality of fingerprint pairs does not match the second portion of the plurality of fingerprint pairs in the fingerprint data.

3. The computer-implemented method of claim 1, wherein the fingerprint data is generated by creating a token space that does not overlap with an existing token space of the AI model.

4. The computer-implemented method of claim 1, wherein the first portion of each of the plurality of validating data sequences is configured to serve as a verification prompt and the second portion of each of the plurality of validating data sequences is configured to serve as a verification response from the AI model.

5. The computer-implemented method of claim 1, wherein comparing the output of the AI model to the fingerprint data further comprises executing the comparison using predetermined hyperparameters to reduce variability in the AI model output.

6. The computer-implemented method of claim 1, further comprising storing the fingerprint data in a fingerprint registry that associates a distinct AI model identifier and version information with the corresponding fingerprint data.

7. The computer-implemented method of claim 1, wherein receiving the request to verify the identity of the AI model further comprises accessing metadata associated with the AI model, the metadata including a distinct AI model identifier that is compared to an identifier stored within the fingerprint data.

8. The computer-implemented method of claim 1, wherein the fingerprint data is embedded into the AI model during a training process that incorporates a distinct token space into at least one layer of the AI model.

9. The computer-implemented method of claim 1, wherein inputting the first portion of each of the plurality of fingerprint pairs into the AI model comprises transmitting the first portion of each of the plurality of fingerprint pairs to the AI model via an application programming interface configured to facilitate an AI model verification process.

10. The computer-implemented method of claim 1, wherein comparing the output of the AI model corresponding to the first portion of each of the plurality of fingerprint pairs to the second portion of the plurality of fingerprint pairs in the fingerprint data comprises determining a similarity level for the match between the output of the AI model and the second portion of the plurality of fingerprint pairs, wherein verifying the asserted identification of the AI model is based on the similarity level exceeding a predetermined threshold.

11. A computer program product having one or more computer readable storage media having computer readable program code collectively stored on the one or more computer readable storage media, the computer readable program code being executed by a processor of a computer system to cause the computer system to perform operations comprising:
receiving a request to verify an identity of an AI model, the request including an asserted identification of the AI model;
obtaining fingerprint data associated with the asserted identification of the AI model, the fingerprint data comprised of a plurality of fingerprint pairs, each having a first portion of a validating data sequence and a second portion of the validating data sequence;
inputting the first portion of one or more of the plurality of fingerprint pairs into the AI model;
comparing an output of the AI model corresponding to the first portion of each of the plurality of fingerprint pairs to the second portion of the plurality of fingerprint pairs in the fingerprint data; and
based on a determination that the output of the AI model corresponding to the first portion of each of the plurality of fingerprint pairs matches the second portion of the plurality of fingerprint pairs in the fingerprint data, verifying that the asserted identification of the AI model is accurate.

12. The computer program product of claim 11, wherein the operations further comprise indicating that the asserted identification of the AI model is inaccurate based on the determination that the output of the AI model corresponding to the first portion of each of the plurality of fingerprint pairs does not match the second portion of the plurality of fingerprint pairs in the fingerprint data.

13. The computer program product of claim 11, wherein the fingerprint data is generated by creating a token space that does not overlap with an existing token space of the AI model.

14. The computer program product of claim 11, wherein the first portion of each of the plurality of validating data sequences is configured to serve as a verification prompt and the second portion of each of the plurality of validating data sequences is configured to serve as a verification response from the AI model.

15. The computer program product of claim 11, wherein comparing the output of the AI model to the fingerprint data further comprises executing the comparison using predetermined hyperparameters to reduce variability in the AI model output.

16. The computer program product of claim 11, wherein the operations further comprise storing the fingerprint data in a fingerprint registry that associates a distinct AI model identifier and version information with the corresponding fingerprint data.

17. The computer program product of claim 11, wherein receiving the request to verify the identity of the AI model further comprises accessing metadata associated with the AI model, the metadata including a distinct AI model identifier that is compared to an identifier stored within the fingerprint data.

18. The computer program product of claim 11, wherein the fingerprint data is embedded into the AI model during a training process that incorporates a distinct token space into at least one layer of the AI model.

19. The computer program product of claim 11wherein inputting the first portion of each of the plurality of fingerprint pairs into the AI model comprises transmitting the first portion of each of the plurality of fingerprint pairs to the AI model via an application programming interface configured to facilitate an AI model verification process.

20. A computing system comprising:
a processor;
a memory coupled to the processor; and
one or more computer readable storage media coupled to the processor, the one or more computer readable storage media collectively containing instructions that are executed by the processor via the memory to cause the processor to perform operations comprising:
receiving a request to verify an identity of an AI model, the request including an asserted identification of the AI model;
obtaining fingerprint data associated with the asserted identification of the AI model, the fingerprint data comprised of a plurality of fingerprint pairs, each having a first portion of a validating data sequence and a second portion of the validating data sequence;
inputting the first portion of one or more of the plurality of fingerprint pairs into the AI model;
comparing an output of the AI model corresponding to the first portion of each of the plurality of fingerprint pairs to the second portion of the plurality of fingerprint pairs in the fingerprint data; and
based on a determination that the output of the AI model corresponding to the first portion of each of the plurality of fingerprint pairs matches the second portion of the plurality of fingerprint pairs in the fingerprint data, verifying that the asserted identification of the AI model is accurate.
